(19) United States
(12) Patent Application Publication
(10) Pub. No.: US 2024/0139884 A1
(43) Pub. Date: May 2, 2024

(54) METHOD FOR PROCESSING A METAL-CERAMIC SUBSTRATE, AND METAL-CERAMIC SUBSTRATE

(71) Applicant: Rogers Germany GmbH, Eschenbach (DE)

(72) Inventors: Thomas Kohl, Auerbach (DE); Bernhard Rettinger, Windischeschenbach (DE)

(21) Appl. No.: 18/279,993

(22) PCT Filed: Mar. 2, 2022
(86) PCT No.: PCT/EP2022/055290

§ 371 Date: Sep. 1, 2023

(30) Foreign Application Priority Data
Mar. 3, 2021 (DE) 10 2021 105 109.6

(51) Int. Cl. B23K 26/364; B23K 26/40

(52) U.S. Cl. CPC B23K 26/364; B23K 26/40; B23K 2103/16

(57) ABSTRACT

A method for machining a metal-ceramic substrate (1), in particular for producing a predetermined breaking point, comprising:
providing a metal-ceramic substrate (1) and
forming a predetermined breaking point (7) in the metal-ceramic substrate (1) wherein the predetermined breaking point (7) has along a direction (V) thereof at least a first portion (A1) having a first depth (T1) and at least a second portion (A2) having a second depth (T2), wherein a second depth (T2) is realized, which is different from the first depth (T1).

### CROSS-REFERENCE TO RELATED APPLICATIONS

This application is a National Stage filing of PCT/EP2022/055290, filed Mar. 2, 2022, which claims priority to DE 10 2021 105 109.6, filed Mar. 3, 2021, both of which are incorporated by reference in their entirety herein.

### BACKGROUND

The present invention relates to a method for machining a metal-ceramic substrate, and a metal-ceramic substrate having a predetermined breaking point.

Electronic modules are well known from the prior art, for example as power electronic modules. Such electronic modules typically use switchable or controllable electronic components that are interconnected on a shared metal-ceramic substrate via conductive tracks. Essential components of the metal-ceramic substrate are an insulation layer, which in the case of the metal-ceramic substrate is made of a material comprising a ceramic, and a metallization layer, which is preferably structured and formed on one component side of the metal-ceramic substrate to form conductive paths.

Typically, a metal-ceramic substrate is realized as a master card, which is separated into smaller metal-ceramic substrates after or before structuring. Such master cards are processed by laser light to produce predetermined breaking points and/or separation points. The respective metal-ceramic substrates can then be separated from the master card, e.g., by breaking them off. The use of ultrashort pulse lasers has proven advantageous here, as described for example in WO 2017/108 950 A1.

Based on this prior art, the present invention aims to improve the production of predetermined breaking points in a metal-ceramic substrate, in particular in a master card.

### SUMMARY

This task is solved by a method for machining a metal-ceramic substrate as described herein and a metal-ceramic substrate as described herein. Further embodiments can be found in the subsequent claims and the description.

According to a first aspect of the present invention a method for machining a metal-ceramic substrate is provided, comprising:
providing a metal-ceramic substrate and
forming a predetermined breaking point in the metal-ceramic substrate wherein the predetermined breaking point has along a direction thereof at least a first portion having a first depth and at least a second portion having a second depth, wherein a second depth is realized, which is different from the first depth.

### BRIEF DESCRIPTION OF THE DRAWINGS

Further advantages and features will be apparent from the following description of preferred embodiments of the subject matter of the invention with reference to the accompanying figures. Individual features of the individual embodiments may thereby be combined within the scope of the invention, wherein in the figures.

FIG. 1: schematic representation of a process for machining a metal-ceramic substrate according to a first exemplary embodiment of the present invention;

FIG. 2a: predetermined breaking point according to the prior art;

FIG. 2b: predetermined breaking point according to a second exemplary embodiment of the present invention; and

FIG. 2c: Predetermined breaking point according to a third exemplary embodiment of the present invention.

### DETAILED DESCRIPTION

Compared to predetermined breaking points known in the prior art, it is provided according to the invention that the first section and the second section provide a first depth and a second depth for the predetermined breaking point, whereby a bottom of the predetermined breaking point is modulated in the direction of the direction of the predetermined breaking point. It has been found that by modulating the bottom of the predetermined breaking point accordingly, in particular with a first section having a first depth and a second section having a second depth different from the first depth, it is possible for the corresponding metal-ceramic substrates to be broken as flawlessly as possible on the one hand and to have a desirable stability on the other hand, which ensures safe transport without the metal-ceramic substrates breaking unintentionally during transport, in particular in the region of the predetermined breaking point. This reduces the overall amount of rejects of metal-ceramic substrates that break incorrectly due to unintentional or untargeted breaking. These are preferably metal-ceramic substrates in the form of master cards.

In particular, it is intended that the first depth and/or second depth is dimensioned from the bottom of the predetermined breaking point in the first section and second section, respectively, in a direction perpendicular to the main extension plane up to an imaginary plane through which the upper side of the metal-ceramic substrate or the ceramic layer also runs. By a first section and second section is meant, in particular, such a section at the bottom of the predetermined breaking point which does not have a diagonally inclined course relative to the main extension plane. In this context, the first section and/or the second section can also be point-shaped, in particular if the second section is immediately followed by a diagonally extending bottom in each case. For example, it may also be a zigzag-shaped course at the bottom of the predetermined breaking point. Preferably, it is provided that between the first section and the second section there is in each case an inclined region, in which the bottom of the predetermined breaking point runs diagonally to the main extension plane.

In other words, the first section and second section in particular do not include those sections of the predetermined breaking point, in which the bottom of the predetermined breaking point runs diagonally with respect to the main extension plane. The portions of the bottom of the predetermined breaking point that do not count as the first section and second section, i.e., the oblique portions, may, for example, run perpendicular to a main extension plane and/or extend at an angle of between 30° and 60°, preferably 40° and 50°, and more preferably between 42° and 48° to the main extension plane. In particular, the respective diagonally extending sections in the bottom of the predetermined breaking point form an inclination which is essentially constant along the direction of extension, i.e., in particular does not deviate from an average value of all inclination angles by more than 10%, preferably 5%, more preferably 2%.

Preferably, the first depth has a value between 0.01 mm and 0.12 mm preferably between 0.02 mm and 0.1 mm and more preferably a value between 0.02 mm and 0.08 mm, while the second depth has a value between 0.01 mm and 0.16 mm preferably between 0.02 mm and 0.12 mm and more preferably a value between 0.02 mm and 0.1 mm.

Furthermore, the metal-ceramic substrate comprises at least one metal layer which is bonded to an upper side of a ceramic element or a ceramic layer, wherein the metal layer and the ceramic element extend along a main extension plane and are arranged one above the other along a stacking direction extending perpendicularly to the main extension plane.

Conceivable materials for the metal layer are copper, aluminum, molybdenum, tungsten and/or alloys thereof, such as CuZr, AlSi or AlMgSi, as well as laminates such as CuW, CuMo, CuAl and/or AlCu or MMC (metal matrix composite), such as CuW, CuMo or AlSiC. Furthermore, it is preferably provided that the metal layer on the manufactured metal-ceramic substrate is surface-modified, in particular as structural metallization. As a surface modification, for example, a sealing with a precious metal, in particular silver, and/or gold, or (electroless) nickel or ENIG (“electroless nickel immersion gold”) or an edge encapsulation on the metal layer to suppress crack formation or expansion is conceivable.

Preferably, the ceramic element has Al₂O₃, Si₃N₄, AlN, an HPSX ceramic (i.e., a ceramic with an Al₂O₃ matrix consisting of an x-percentage of ZrO₂, for example Al₂O₃ with 9% ZrO₂═HPS9 or Al2O3 with 25% ZrO₂═HPS25), SiC, BeO, MgO, high-density MgO (>90% of the theoretical density), TSZ (tetragonally stabilized zirconium oxide) as material for the ceramic. It is also conceivable that the ceramic element is configured as a composite or hybrid ceramic, in which several ceramic layers, each differing in terms of their material composition, are arranged on top of one another and joined together to form a ceramic element in order to combine various desired properties. Preferably, a ceramic that is as thermally conductive as possible is used for the lowest possible thermal resistance.

Preferably, the metal layer is bonded to the insulating layer by means of an AMB process and/or a DCB process and/or hot isostatic pressing. It is also conceivable to bond by means of a diffusion bonding process or by a thick-film coating process.

The skilled person understands a “DCB process” (direct copper bond technology) or a “DAB process” (direct aluminum bond technology) to mean such a process, which is used, for example, to bond metal layers or sheets (e.g., copper sheets or foils or aluminum sheets or foils) to one another and/or to ceramics or ceramic layers, using metal or copper sheets or metal or copper foils which have a layer or coating (fusion layer) on their surface sides. In this process, described for example in U.S. Pat. No. 3,744,120 A or in DE23 19 854 C2, this layer or coating (fusion layer) forms a eutectic with a melting temperature below the melting temperature of the metal (e.g., copper), so that by placing the foil on the ceramic and by heating all the layers, they can be bonded to each other by melting the metal or copper essentially only in the region of the fusion layer or oxide layer.

In particular, the DCB process then has, for example, the following process stages:
Oxidizing a copper foil in such a way that a uniform copper oxide layer is formed;
Placing the copper foil on the ceramic layer;
Heating the composite to a process temperature between about 1025 to 1083° C., e.g., to about 1071° C.;
Cooling to ambient temperature.

An active solder process, e.g., for bonding metal layers or metal foils, in particular also copper layers or copper foils with ceramic material, is understood to be a process which is specifically also used for the production of metal-ceramic substrates, a bond is produced between a metal foil, for example copper foil, and a ceramic substrate, for example aluminum nitride ceramic, at a temperature between approx. 650-1000° C. using a solder which, in addition to a main component such as copper, silver and/or gold, also contains an active metal. This active metal, which is for example at least one element of the group Hf, Ti, Zr, Nb, Ce, establishes a bond between the brazing solder and the ceramic by chemical reaction, while the bond between the brazing solder and the metal is a metallic brazing solder joint. Alternatively, a thick coating process is conceivable for bonding.

It is preferably provided that in hot isostatic pressing a container, in particular a metal container, is subjected in a heating and pressure device to a gas pressure of between 100 and 2000 bar, preferably 150 bar and 1200 bar and more preferably 300 and 1000 bar and a process temperature of 300° C. up to a melting temperature of a metal layer and/or a further metal layer, in particular up to a temperature below the melting temperature of the metal layer and/or the further metal layer.

Advantageously, it has been found that it is thus possible to bond a metal layer, i.e., the metal layer and/or the further metal layer of the metal container, to the ceramic element without reaching the required temperatures of a direct metal bonding process, for example a DCB process or a DAB process, and/or without a solder base material used in active soldering. In addition, the benefit or use of an appropriate gas pressure allows the possibility of producing a metal-ceramic substrate as free of voids as possible, i.e., without gas inclusions between the metal layer and the ceramic element. In particular, process parameters are used which are mentioned in DE 10 2013 113 734 A1 and which are hereby explicitly referred to in connection with hot isostatic pressing.

Preferably, it is provided that particles produced during the creation of the predetermined breaking point are sucked off by means of a suction device. Such suction devices cause a suction stream, which is configured in particular in such a way that the ceramic particles produced during processing, in particular by sublimation, are sucked off the upper side of the metal-ceramic substrate. Preferably, in this case, the suction device is arranged essentially at the level of the metal-ceramic substrate and causes a suction stream to run essentially parallel to the main extension plane of the substrate, in particular in the vicinity of the substrate surface. As a result, the ceramic particles formed by sublimation are sucked off to the side during treatment with the laser pulses.

Preferably, it is provided that the metal-ceramic substrate is arranged stationary during the formation of the predetermined breaking point and/or that the laser light is moved over the metal-ceramic substrate for forming the predetermined breaking point, i.e., the metal-ceramic substrate is preferably arranged stationary during the processing for the purpose of producing predetermined breaking points for separating the metal-ceramic substrates. “stationary” means either fixed at a location or rotatably/swivably fixed at a location. For this purpose, for example, the metal-ceramic substrate, which is preferably provided as a master card, is fixed in a holding element. Such a holding element comprises, for example, a suction device which fixes the metal-ceramic substrate in the holding element during the process by means of a corresponding vacuum on the underside of the metal-ceramic substrate. By fixing or stationarily arranging the metal-ceramic substrate during the production of the predetermined breaking points, finer-structured and more precisely shaped predetermined breaking points can be produced in an advantageous manner, in particular if multiple passes of the laser beam over the metal-ceramic substrate are provided. Preferably, a laser beam of the UKP system is moved along the planned course of the predetermined breaking points, preferably in several passes. The laser beam traversing the metal-ceramic substrate has a processing speed of between 0.1 and 2 m per second, preferably between 0.8 and 1.5 m per second.

Preferably, the first sections and the second sections are realized outside crossing points of two predetermined breaking points. This ensures the advantageous fracture behaviour over the entire master card and a targeted weakening is not set only in areas of crossing points located one above the other. In particular, it is intended that the first section or the second section is not formed exclusively in crossing points of two predetermined breaking points. In particular, predetermined breaking points intersecting at a crossing point run perpendicular to one another in order to divide the master card in a checkerboard fashion by means of the predetermined breaking points.

Preferably, it is provided that a ratio of a first depth T1 to a second depth T2 is between 0.05 and 1, preferably between 0.2 and 0.8, and more preferably between 0.4 and 0.6. It has been found that, in particular at a second depth which is approximately twice as large as the first depth, a metal-ceramic substrate having a predetermined breaking point which is particularly well suited for handling can be provided, which at the same time has sufficiently good breaking behaviour along the predetermined breaking point.

Furthermore, it is particularly preferable that the first depth in the first section remains substantially constant over a first length dimensioned in the direction of the predetermined breaking point and/or the second depth in the second section remains substantially constant over a second length dimensioned in the direction of the predetermined breaking point. The production of a corresponding modulation in which in particular the first length and/or the second length is constant over a certain period of time can be realized quickly and without great effort.

Preferably, the first length has a value between 0.05 mm and 5.0 mm, preferably between 0.05 mm and 2.0 mm and more preferably a value between 0.05 mm and 0.01 mm, while the second length has a value between 0.05 mm and 5.0 mm, preferably between 0.05 mm and 2.0 mm and more preferably a value between 0.05 mm and 0.01 mm.

Furthermore, it is particularly preferable to provide that a ratio of the first length to the second length is less than 1.5, preferably less than 0.5 and more preferably less than 0.25.

In particular, it is particularly preferable to provide that the first length is approximately equal to the second length, which results in a particularly symmetrical course of the bottom of the predetermined breaking point with respect to its modulation. In particular, the interval also includes such ratios where the first section is point-shaped and thus the ratio is substantially 0. In these embodiments, the bottom section forms a substantially triangular shape in a cross-section that is perpendicular to the main extension plane and through the direction of the section.

It is particularly preferable if a predetermined breaking point is produced on the metal-ceramic substrate on the upper side and the lower side, which are arranged substantially congruent with one another in a direction running perpendicular to the main extension plane. In this context, it is conceivable that the first sections and the second sections on the upper side are arranged at the same position or offset with respect to each other, as seen in the direction, relative to the corresponding first sections and second sections on the lower side.

Preferably, it is provided that the first section and the second section alternate periodically. In other words, along the direction, apart from the connecting oblique courses of the arches of the predetermined breaking point, the first section and the second section alternate continuously. Preferably, sloping areas are formed between the first section and the second section.

Preferably, the predetermined breaking point has a third depth in a direction perpendicular to the direction, which preferably differs from the first and/or second depth. This forms, for example, a W-shaped or W-like profiling of the predetermined breaking point in a plane or cross section perpendicular to the direction. Such a deepening can be achieved, for example, by slightly offsetting the laser light during a few passes with respect to the further passes with the laser light that lead to the formation of the predetermined breaking point.

Preferably, the predetermined breaking point in the first section or second section has a trapezoidal or triangular shape in a plane parallel to the direction. This results in a substantially advantageous bottom section for the predetermined breaking point.

Preferably, it is provided that the predetermined breaking point is produced by machining by means of laser light, in particular an ultrashort pulse laser, wherein, in the course of forming the predetermined breaking point, the metal-ceramic substrate is subjected to a temperature treatment before machining, during machining, and/or after machining, wherein especially cooling, in particular after machining, is carried out at a cooling rate of less than 4° per minute, preferably less than 2° per minute and more preferably less than 0.5° per minute. It has been found that targeted temperature treatment, in particular targeted cooling of the metal-ceramic substrate, can prevent thermomechanical stresses in the manufactured metal-ceramic substrate, which can permanently improve the thermal shock resistance of the fractured metal-ceramic substrate.

Preferably, the UKP laser is a laser source that provides light pulses with a pulse duration of 0.1 to 800 ps, preferably 1 to 500 ps, more preferably 10 to 50 ps. It has proven particularly advantageous to produce predetermined breaking points by means of such pulses, in particular with processing speeds between 0.2 and 8 m/s, which have a particularly favourable ratio between fused ceramic and crack formation within the predetermined breaking points, whereby particularly reliable or successful breaking along the predetermined breaking points can be ensured without damage occurring to the singled metal-ceramic substrate during breaking. In particular, compared to processing with a CO₂ laser, lower stresses are introduced into the metal-ceramic substrate, which can influence the mechanical properties of the ceramic and can otherwise easily expand, induced by the metallization of the metal-ceramic substrate. This can either cause a scrap or at least affect the lifetime of the metal-ceramic substrate. It has been shown that this effect of using ultrashort pulse laser light is particularly pronounced when the use of pulse laser light is accompanied by temperature treatment. In particular, the success rate of fracturing the metal-ceramic substrates can be further improved.

Another object of the present invention is a metal-ceramic substrate with a predetermined breaking point, produced by the process according to the invention. All of the properties and advantages described for the method apply analogously to the metal-ceramic substrate. In particular, the metal-ceramic substrate, especially as a master card, is specified by having a first portion having a first depth and a second portion having a second depth, the first depth being different from the second depth.

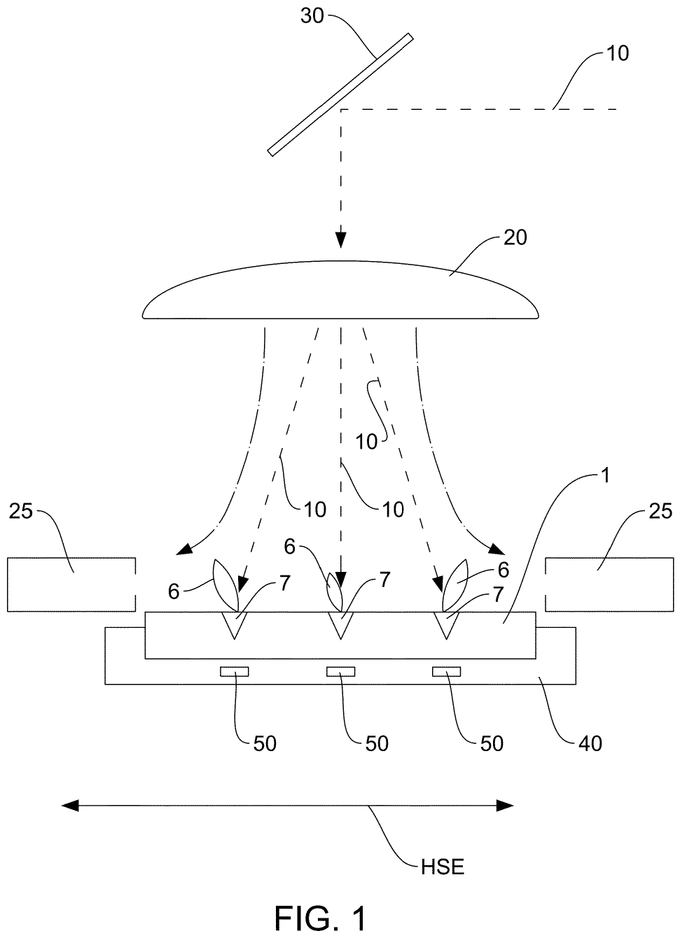

FIG. 1 schematically illustrates a method for machining a metal-ceramic substrate 1 according to a first exemplary embodiment of the present invention. Such a metal-ceramic substrate 1 preferably acts in particular as a carrier for electronic or electrical components, which can be connected to the metal-ceramic substrate 1. Essential components of such a metal-ceramic substrate 1 are a ceramic layer or a ceramic element extending along a main extension plane HSE and a metal layer bonded to the ceramic layer. The ceramic layer is made of at least one material comprising a ceramic. In this case, the metal layer and the ceramic layer are arranged one above the other along a stacking direction extending perpendicularly to the main extension plane HSE and, in a manufactured state, are firmly bonded to one another at least in regions via a bonding surface. Preferably, the metal layer is then structured to form conducting paths or connection points for the electrical components. For example, this structuring is etched into the metal layer. In advance, however, a permanent bond, in particular a firmly bonded bond, must be formed between the metal layer and the ceramic layer.

In order to permanently bond the metal layer to the ceramic layer, a system for producing the metal-ceramic substrate, in particular in a DCB or DAB bonding process, comprises a furnace, in which a stacked arrangement of a ceramic layer and at least one metal layer is heated and the bond is thus achieved. For example, the metal layer is a metal layer made of copper, wherein the metal layer and the ceramic layer are bonded together using a DCB (direct copper bonding) process. Alternatively, the metal layer can be bonded to the ceramic layer, using an active soldering process or a thick-film process. It is also conceivable to bond by means of a hot isostatic process or by means of diffusion bonding.

After bonding, in particular by means of a DCB process, an active soldering process, a diffusion bonding process, hot isostatic pressing, and/or a thick-film coating process, the metal-ceramic substrate 1 is provided as a master card. Such master cards are to be singulated in the subsequent process in order to provide singulated metal-ceramic substrates 1 in each case. Preferably, for such a separation, it is intended to process the master card by means of laser light 10, in particular by means of ultrashort pulse laser light. In doing so, it is possible to immediately realize a separation by means of the laser light 10 and/or to form a predetermined breaking point 7 along which the master card is broken in the subsequent process, forming the singulated metal-ceramic substrates 1. By an ultrashort pulse laser, the skilled person understands in particular such laser sources that emit laser pulses, whose pulse length is less than a nanosecond. Preferably, the pulse duration is between 0.1 and 100 ps. Furthermore, it is conceivable that the pulse duration is in the femtosecond range, i.e., the pulse length is 0.1 to 100 fs. Alternatively, the use of a CO₂ laser is also conceivable. In the explementary embodiment shown in FIG. 1, the metal-ceramic substrate 1 is arranged in a holding element 40.

In particular, it is intended that the metal-ceramic substrate 1 is fixed in place by means of the holding element 40. In order to generate a predetermined breaking point 7 u, which in particular has a specific course along a direction V over the metal-ceramic substrate 1, it is provided that laser light 10 or a laser beam is moved over the metal-ceramic substrate 1. In other words, instead of moving the metal-ceramic substrate 1 relative to the laser light 10 or its alignment, it is preferable to provide the alignment of the laser light 10 or laser beam in such a way that the laser light 10 travelled over the metal-ceramic substrate 1 generates a predetermined breaking point 7 and/or a cut line at the respective impact points. It is conceivable that the predetermined breaking point 7 is continuous and/or interrupted, i.e., the predetermined breaking point 7 is present as a perforation. In this case, the laser light 10 travelled over the metal-ceramic substrate 1 has a processing speed of between 0.1 and 2 m/s, preferably between 0.8 and 1.5 m/s. Alternatively, it is conceivable that the metal-ceramic substrate 1 is displaced to change the position of the laser light 10 impacting the metal-ceramic substrate 1.

In particular, to align the laser light 10, it is contemplated that the laser light 10 is directed to a mirror element 30. The laser light 10 is reflected at the mirror element 30 and subsequently impacts the metal-ceramic substrate 1. In this context, it is particularly provided that the mirror element 30 is pivotably mounted, in particular pivotably mounted about at least two axes, in order to align the laser light 10 with a specific treatment area or specific areas on the metal-ceramic substrate 1. Furthermore, it is preferable that a lens 20, preferably an f⊖-lens, is arranged between the mirror element 30 and the metal-ceramic substrate 1. In particular, the lens 20 extends along a plane substantially perpendicular to the impact direction of the laser light 10 substantially over a length corresponding to the length and/or width of the metal-ceramic substrate 1, in particular as a master card. In other words, the laser light 10 traveling over the metal-ceramic substrate 1 always passes through the same lens 20 regardless of the processing area.

It has been found to be particularly advantageous to use a lens 20 whose focal length is greater than 300 mm, preferably greater than 350 mm and particularly preferable greater than 420 mm. Arranging the lens 20 at a distance from the metal-ceramic substrate 1, which essentially corresponds to the focal length of the lens 20, then makes it possible to create predetermined breaking points or predetermined breaking depressions 7, which are comparatively slightly inclined with respect to a perpendicular direction being perpendicular to the main extension plane HSE of the metal-ceramic substrate 1. Otherwise, an angle of inclination that is essentially V-shaped or notch-shaped predetermined breaking points 7 would have to be expected. This applies in particular to predetermined breaking points 7, which are formed at the edge of the metal-ceramic substrate 1. Such a slanted position is caused in particular by the fact that the laser light 10 or the laser beams, as seen over the entire extent of the metal-ceramic substrate 1, cannot impinge uniformly perpendicular on the metal-ceramic substrate 1.

However, by using the focal length greater than 300 mm, this inclination, in particular in the edge regions of the metal-ceramic substrate 1, is reduced in such a way that an angle of inclination, measured or referred to the perpendicular direction of the metal-ceramic substrate 1, is smaller than 12°, particularly preferable smaller than 10°. In particular, it is found that a deviation of the angle of inclination compared to the orientation of the predetermined breaking point 7 in the centre of the metal-ceramic substrate 1 does not become larger than 12°. Thus, it is advantageously possible to create predetermined breaking points 7 whose fracture behaviour is homogeneously distributed substantially over the entire metal-ceramic substrate 1.

Furthermore, a suction device 25 is provided. The suction device 25 is arranged laterally offset from the metal-ceramic substrate 1 or the holding element 40. The suction device 25 has an opening through which a gas can be sucked in. In particular, the suction device 25 serves to ensure that sublimated particles are sucked off the surface or the upper side of the metal-ceramic substrate 1 during the machining process. These sublimated particles of ceramic are the result of a plasma formation or a plasma flame 6 generated during the processing of the metal-ceramic substrate 1 by means of ultrashort pulse laser light. In addition to a lateral arrangement, an arrangement of the suction device 25 above the metal-ceramic substrate 1 to be divided is also conceivable, in which the opening is directed towards the metal-ceramic substrate 1.

In particular, it is provided that the metal-ceramic substrate 1 is subjected to a temperature treatment in the course of the production of the predetermined breaking point 7 temporally before a machining and/or during the machining and/or after the machining with the laser light 10 for the production of the predetermined breaking point 7. In particular, the temperature treatment is configured to control the temperature development in the metal-ceramic substrate 1 in such a way that sudden or strong temperature changes are avoided. This advantageously reduces the formation of thermomechanically induced stresses in the metal-ceramic substrate 1. This in turn leads to the fact that the thermal shock resistance of the manufactured, in particular divided, metal-ceramic substrate 1 is improved, the inclination to shell fracture is reduced and the inclination to cracks running in particular vertically can be reduced.

In particular, the skilled person understands by “in the course of producing the predetermined breaking point” that the temperature increase takes place for machining with the laser light 10 and does not refer to temperature increases that occur previously, for example when bonding the metal layer to the ceramic layer in the course of a DCB process and/or active soldering process, or after manufacturing the metal-ceramic substrate 1, for example in the case of heat developments occurring during operation. For this purpose, for example, heating of the metal-ceramic substrate 1 takes place within 15 minutes, preferably 10 minutes and more preferably 5 minutes, before machining 103 of the metal-ceramic substrate 1 to produce the predetermined breaking point 7. The same applies to temperature treatment after machining with the laser light 10.

For example, for this purpose the metal-ceramic substrate 1 is heated before the machining or before the machining with the laser light 10, in particular to a temperature greater than 40° C., preferably greater than 80° C. and more preferably greater than 150° C. In particular, it is thereby provided that the heating 102 results in the heat input, which is carried out by the laser pulse itself and preferably results in a short-term heat input, being reduced in proportion. In particular, for this purpose, the temperature treatment is carried out at a heating rate of less than 5° C./min, preferably less than 3° C./min and more preferably less than 0.5° C./min.

Preferably, cooling is provided at a cooling rate of less than 4° C./min, preferably less than 2° C./min and more preferably less than 0.5° C./min. Temperature treatment during machining of the metal-ceramic substrate 1 means in particular that, for example, in the case of multiple passes of a position, the laser beam or the laser light 10 passes the same position in a first pass and then in a second pass. By means of a specifically adjustable time interval between the first pass and the second pass, cooling of the metal-ceramic substrate 1 during machining can be caused in a targeted manner. Alternatively, or additionally, it is also conceivable that in addition to setting the time interval until the second pass, the metal-ceramic substrate 1 is additionally cooled. This makes it possible to shorten the time interval until the second pass, which accelerates the entire manufacturing process for producing or machining the metal-ceramic substrate 1 while forming the predetermined breaking point 7.

In order to carry out a temperature treatment of the metal-ceramic substrate 1 in a targeted manner, it is conceivable, for example, that the holding element 40 has heating elements 50, for example, which are preferably arranged in a direction running perpendicular to the main extension plane HSE below the predetermined breaking points 7 or the planned predetermined breaking points 7. In this regard, corresponding heating elements 50 may be arranged, for example, within the holding element 40 and/or may be mounted on an outer side of the holding element 40. For example, the heating elements 50 are directly adjacent to the metal-ceramic substrate 1 when the holding element 40 is equipped with the metal-ceramic substrate. Furthermore, it is preferable that the holding element 40 positively and/or non-positively fixes the metal-ceramic substrate 1 in a direction parallel to the main extension plane HSE. As a result, the retaining element 40 can additionally be used for positioning the metal-ceramic substrate 1. Alternatively, to the formation of heating elements 50 inside or on the outside of the holding element 40, it is also conceivable and/or complementarily conceivable that the entire holding element 40 is heated and/or selectively cooled for heating and/or cooling the metal-ceramic substrate 1. For this purpose, the holding element 40 is preferably made of a material having a comparatively high thermal conductivity, in particular a thermal conductivity which is greater than 100 W/mK, preferably greater than 200 W/mK and particularly preferably greater than 400 W/mK.

Preferably, the holding element 40 is heated, for example, by means of heating coils or heating elements 50 which are distributed regularly and/or irregularly in or on the holding element 40. Preferably, the heating coils or heating elements 50 are arranged at least partially congruently below the planned predetermined breaking point 7 in a direction perpendicular to the main extension plane HSE.

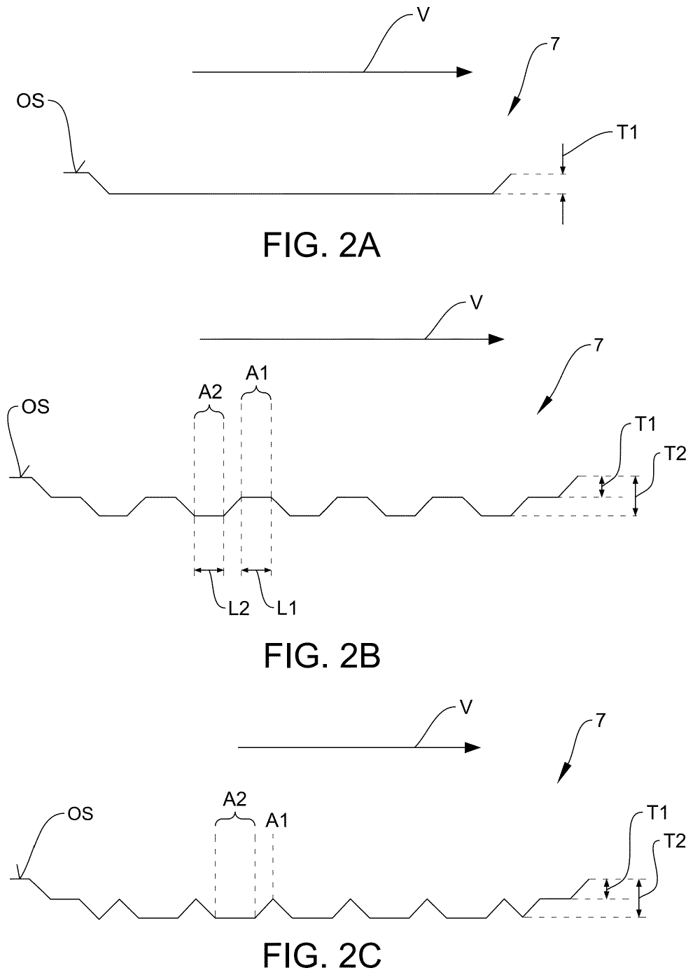

FIG. 2a shows a predetermined breaking point 7 according to the state of the art. In particular, it is a sectional view along the direction V, through which a profile of the predetermined breaking point 7 can be seen, in particular at its bottom or base. The predetermined breaking point 7, in particular recessed in the ceramic layer, has a first depth T1, measured in a direction perpendicular to the main extension plane HSE between an upper surface OS of the metal-ceramic substrate 1, in particular the ceramic layer of the metal-ceramic substrate 1, in which the predetermined breaking point 7 is recessed, and the bottom. In this context, the first depth T1 is in particular always referred to as a plane which continues the upper side OS of the ceramic layer in terms of thought, i. e. a plane, which runs parallel to the upper side OS. The exemplary embodiment according to the prior art shows that, apart from courses extending diagonally to the main extension plane, the predetermined breaking point 7 according to the prior art has a substantially constant first depth T1 at the beginning and at the end. In this context, the skilled person understands a first constant depth T1 to be one that varies less than 10%, less than 5%, and less than 2% along the direction V of travel.

FIG. 2b shows a predetermined breaking point 7 according to a preferred embodiment of the present invention. In particular, the predetermined breaking point 7 of FIG. 2b has a first section A1 and a second section A2, wherein a first depth T1 of the first section A1 differs from a second depth T2 of the second section A2. In particular, a first section A1 or a second section A2 is understood to be such a partial section of the predetermined breaking point 7 or of the bottom of the predetermined breaking point 7, respectively, which runs along the direction V essentially parallel to the main extension plane HSE. In other words, the first sections Al and second sections A2 in the predetermined breaking point 7 exclude the sections on the bottom or the predetermined breaking point 7 that run essentially diagonally to the main extension plane HSE and, for example, connect the upper surface OS with the first section A1 and/or the first section A1 with the second section A2.

In the exemplary embodiment shown in FIG. 2b, a first length L1 of the first section A1 dimensioned parallel to the direction V substantially corresponds to a second length L2 of the second section A2. Furthermore, it can be seen from FIG. 2b that the second depth T2 of the second section A2 is substantially twice as large as the first depth T1 in the first section A1. Furthermore, it is preferable that the first section A1 and the second section A2 alternate in the direction of the direction V, thereby forming a periodic pattern of the bottom of the predetermined breaking point 7. It has been found that forming predetermined breaking points 7 with different depths, i. e. at least a first depth T1 and a second depth T2 for a first distance A1 and a second section A2, is suitable for providing sufficient stability of the metal-ceramic substrate 1, in particular in the form of a master card, thereby allowing in particular its transportation. At the same time, the different depths T1, T2 allow an almost exclusion-free breaking along the predetermined breaking point 7.

In particular, it is provided that the bottom of the predetermined breaking point 7 is modulated continuously, in particular continuously periodically, along the direction V, so as to form a first section A1 and a second section A2. In particular, it is provided that the bottom has a trapezoidal and/or triangular cross-section in the sectional view perpendicular to the main extension plane HSE and passing through the direction V.

To produce such a predetermined breaking point 7, it is conceivable, for example, that the laser light 10 is passed over the ceramic layer more often in the second sections A2 than in the first section A1. Alternatively, it is conceivable that after a depression with a first depth T1 has been produced, a masking element, in particular an appropriately patterned masking element, is placed on the ceramic layer so that light only reaches the ceramic layer through the non-shaded areas in the masking element and causes the ceramic material to be removed there. In this way, appropriately modulated predetermined breaking points 7 can be realized. In the exemplary embodiment of the present invention shown in FIG. 2c, it is further provided that the second length L2 of the second section A2 is greater than the first length L1 of the first section A1. In particular, it is provided that the first section A1 is substantially point-shaped so as to form a triangular shape at the bottom of the predetermined breaking point 7.

### LIST OF REFERENCE SIGNS

1 Metal-ceramic substrate
6 Plasma flame
7 Predetermined breaking point
10 Laser light
20 Lens
25 Suction device
30 Mirror element
50 Heating element
A1 First section
A2 Second section
T1 First depth
T2 Second depth
V Direction
OS Upper surface
HSE Main extension plane

1-10. (canceled)

11. A method for machining a metal-ceramic substrate (1), comprising:
providing a metal-ceramic substrate (1) and
forming a predetermined breaking point (7) in the metal-ceramic substrate (1), wherein the predetermined breaking point (7) has along a direction (V) thereof at least a first portion (A1) having a first depth (T1) and at least a second portion (A2) having a second depth (T2), wherein a second depth (T2) is realized, which is different from the first depth (T1), wherein the first sections (A1) and the second sections (A2) are realized outside crossing points of two predetermined breaking points (7), the first depth (T1) in the first section (A1) remains substantially constant over a first length (L1), dimensioned in the direction (V) of the predetermined breaking point (7), and the second depth (T2) in the second section (A2) remains substantially constant over a second length (L2), dimensioned in the direction (V) of the predetermined breaking point (7).

12. The method according to claim 11, wherein a ratio of a first depth (T1) to a second depth (T2) has a value between 0.2 and 0.8.

13. The method according to claim 11, wherein a ratio of a first depth (T1) to a second depth (T2) has a value between 0.3 and 0.7.

14. The method according to claim 11, wherein a ratio of a first depth (T1) to a second depth (T2) has a value between 0.4 and 0.6.

15. The method according to claim 11, wherein a ratio of the first length (L1) to the second length (L2) is less than 1.5.

16. The method according to claim 11, wherein a ratio of the first length (L1) to the second length (L2) is less than 0.5.

17. The method according to claim 11, wherein a ratio of the first length (L1) to the second length (L2) is less than 0.25.

18. The method according to claim 11, wherein the first section (A1) and the second section (A2) alternate periodically.

19. The method according to claim 11, wherein the predetermined breaking point (7) has a third depth in a direction perpendicular to the direction (V).

20. The method according to claim 19, wherein the third depth is different from the first depth (T1) and/or the second depth (T2).

21. The method according to claim 11, wherein the predetermined breaking point (7) has a trapezoidal or triangular shape in a plane running parallel to the direction (V).

22. The method according to claim 11, wherein the predetermined breaking point (7) is produced by machining by means of laser light (10), wherein, in the course of forming the predetermined breaking point (7) the metal-ceramic substrate (1) is subjected to a temperature treatment before machining, during the machining and/or after the machining.

23. The method according to claim 22, wherein the laser light (10) is an ultrashort pulse (UKP) laser.

24. The method according to claim 22, wherein after the machining, a cooling is performed.

25. The method according to claim 24, wherein the cooling has a cooling rate of less than 4° C./min.

26. The method according to claim 24, wherein the cooling has a cooling rate of less than 2° C./min.

27. The method according to claim 24, wherein the cooling has a cooling rate of less than 0.5° C./min.

28. A metal-ceramic substrate with a predetermined breaking point (7) produced by a method according to claim 11.
